(19) United States
(12) Patent Application Publication
(10) Pub. No.: US 2015/0160674 A1
(43) Pub. Date: Jun. 11, 2015

(54) Automatic Load Share Architecture For Usb Port Power

(71) Applicant: Microchip Technology Incorporated, Chandler, AZ (US)

(72) Inventors: William Burdette, Tucson, AZ (US); Jim Nolan, Chandler, AZ (US); Jimmy Yu, Chandler, AZ (US)

(21) Appl. No.: 14/565,919

(22) Filed: Dec. 10, 2014

Related U.S. Application Data
(60) Provisional application No. 61/914,860, filed on Dec. 11, 2013.

(51) Int. Cl. G05F 1/66; G06F 13/20

(52) U.S. Cl. CPC G05F 1/66; G06F 13/20

(57) ABSTRACT

A method, device and system for efficient allocation of an available current supply to a first and second USB power port. The current drawn by a device connected to the first power port is measured and the first power port designated as a priority port. A first current limit is assigned to the priority port, where the selected first current limit is the lowest available current limit setting that is greater than the measured current draw on the priority port. A second current limit is assigned to the second power port, where the assigned second current limit is the highest available current limit setting that is less than or equal to the available current minus the first current limit. The current drawn on the priority port is periodically measured and the first current limit and the second current limit are adjusted accordingly to efficiently distribute the available current.

### CROSS-REFERENCE TO RELATED APPLICATIONS

This application claims the benefit of U.S. Provisional Application No. 61/914,860 filed on Dec. 11, 2013, which is incorporated herein in its entirety.

### TECHNICAL FIELD

The present disclosure relates to universal serial bus (USB) interfaces, in particular to automatic allocation of available current among USB ports.

### BACKGROUND

The Universal Serial Bus (USB) standard was developed to offer PC users an enhanced and easy-to-use interface for connecting a wide range of peripherals to desktop and laptop computers. Among the many benefits of USB is a reduction in the proliferation of cables and connectors that resulted from the ever-expanding computer peripheral industry. USB has become the interface of choice for PCs because it offers simple connectivity and a standardized interface that has proven effective for communicating with a vast array of peripheral devices. In addition to providing a standardized form of communications, USB provides the ability to transfer power bi-directionally along a USB cable. Building on advances in battery technology, peripherals powered at least in part by internal, rechargeable batteries have become common in the marketplace. USB has become a popular mechanism for charging battery-powered peripheral devices. For many peripheral devices, USB is the sole interface provided for charging the peripheral's batteries.

Most desktop and laptop PCs have two or more USB ports. USB hubs can also be used to multiply the number of available USB ports. In general, each of these USB ports is a “power port” that provides the capability of powering and charging a peripheral device connected to the power port via a USB connector. However, a problem arises due to the limited amount of power available to the USB port power switch that regulates the power provided to power ports. Due to this upper limit on the amount of power available to power ports, the available power must be allocated among the power ports by the USB port power switch. In maintaining its power budget, the USB power port switch must efficiently allocate the available power among the peripheral devices that have been connected to the power ports.

A difficulty in efficient allocation of power among the power ports results from the variable nature of the power requirements of USB peripheral devices. As the charge level of a peripheral's internal battery changes over time, the current drawn from the power port by the peripheral device also changes. As the power requirements of peripheral devices change, the available power can be reallocated among the power ports. This provides an opportunity for improving efficiency in USB power capabilities by providing automatic re-allocation of available charging current among a set of power ports that share a common power port switch.

### SUMMARY

Conventional systems that distribute power to USB power ports fail to provide efficient allocation of power that accounts for changing power demands of the downstream devices connected to the power ports. Hence, there is a need for a load sharing control device that is capable of efficiently allocating available power to USB power ports and maintaining an efficient allocation of power that is responsive to changing power requirements in downstream devices. These and other drawbacks in the prior art are overcome in large part by devices, systems and methods according to embodiments of the present invention.

According to an embodiment, a load sharing control device measures the current drawn by a first device that is connected to a first power port of the load sharing control device. The load sharing control device has a total current limit, which is the maximum current that can be provided across all power ports supported by the load sharing control device. The first port of the load sharing control device is designated as a priority port in response to the connection of the first device to this first port. The load sharing control device assigns a first current limit to the priority port, with the assigned first current limit being the lowest current limit setting of the load sharing control device that is greater than the measured current draw of the first device connected to the priority port. The load sharing control devices also assigns a second current limit to a second port of the load sharing control device. The second current limit is the highest current limit setting of the load sharing control device that is less than or equal to the total current limit of the load sharing control device minus the first current limit.

Further embodiments of a load sharing control device may include updating the measurement of the current drawn by the first device after waiting a predefined time interval and updating the first current limit assignment and the second current limit assignment based on the updated measurement of the current drawn by the first device. Further embodiments of a load sharing control device may also include assigning a failsafe current level to the second port wherein the failsafe current level is deducted from the total current limit of the load sharing control device. Further embodiments of a load sharing control device may include detecting the disconnection of the first device from the priority port and designating the second port of the load sharing device as the priority port. Further embodiments of a load sharing control device may include selecting the first current limit and the second current limit from a set of discrete output current limits supported by the load sharing control device. Further embodiments of a load sharing control device may include issuing a request to boost the total power available to the load sharing control device, so that the load sharing control device can increase the power output of supported power ports. Further embodiments of a load sharing control device may include configuring the total current limit of the load sharing control device.

### BRIEF DESCRIPTION OF THE DRAWINGS

The present invention may be better understood, and its numerous objects, features, and advantages made apparent to those skilled in the art, by referencing the accompanying drawings. The use of the same reference symbols in different drawings indicates similar or identical items.

FIG. 1 depicts a routine for automatic load sharing according to some embodiments.

FIG. 2 depicts three scenarios that apply the load sharing routine depicted in FIG. 1.

FIG. 3 depicts a load sharing system configured for allocating power to two downstream USB devices.

FIG. 4 is a circuit diagram for a load sharing device.

### DETAILED DESCRIPTION

USB hosts routinely provide two or more USB power ports. In such systems, the power budget must be managed by allocating available power between the supported power ports. Changes in the charge level of batteries of downstream devices connected to the power ports effects the demand for power. Consequently, the power budget must be repeatedly adjusted in response to these changes. Conventional systems that are capable of automatically allocating power between USB power ports are unable to manage this power budget efficiently. Conventional systems attempting to provide continuous adjustments to the power port current limits require significant power to implement such solutions. Additionally, such conventional systems attempting to provide continuous monitoring and adjustment of power port output currents require significant overhead. Furthermore, such conventional systems fail to provide assurances that current limits will not be dropped below levels required for downstream USB devices to maintain minimal charge levels in internal batteries or for downstream USB devices to enumerate. Consequently, conventional systems are prone to dropping current levels on power ports past these threshold current levels. The resulting current starvation in the power ports results in connection to the downstream devices being dropped.

By repeating the load sharing routine over time, the port power controller is able to automatically adapt to changing conditions in the current demand by reallocating available power. This promotes efficient use of the power budget that is available to the port power controller and promotes efficient charging of connected USB devices. Users benefit by being able to charge multiple USB devices in a shorter amount of time.

According to various embodiments, a USB interface can be provided that maintains a power budget automatically by re-assigning current limits as loads drawn by downstream devices change. According to various embodiments, the first downstream device to be plugged into the USB interface is given priority in the allocation of the available power budget and a second-connected downstream device is assigned a failsafe current that avoids current starvation.

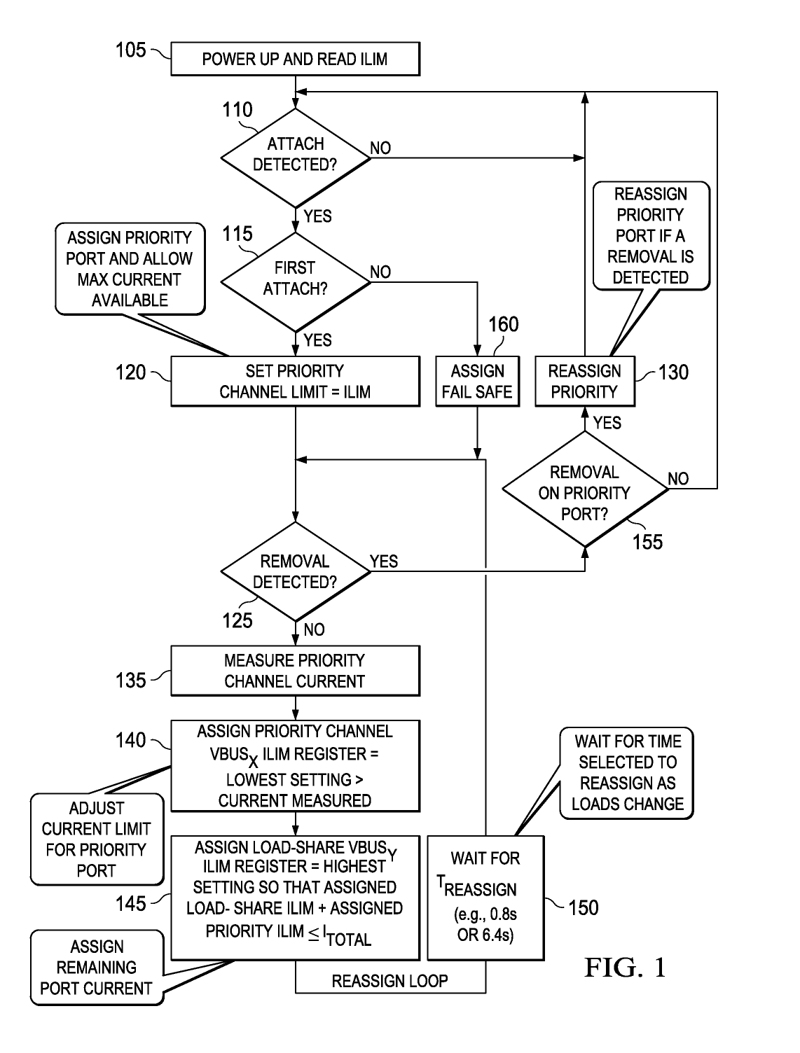

FIG. 1 is a flow chart that illustrates a load sharing routine according to various embodiments. The process may begin at step 105, with the load sharing control device being powered. Upon being powered, the load sharing control device determines the current limit (ILIM) that specifies the maximum output current for the port power switch or other component of the USB interface that may house the load sharing control device according to various embodiments. This output current of each of the power ports is the current supplied on the Vbus line of the USB interface supported by the load sharing control device. According to various embodiments, two or more power ports are supported by a load sharing control device. The current available to the load sharing control device, which is specified by the current limit value (ILIM), is allocated among the supported power ports. In some embodiments, current limit information is provided to the load sharing control device via a pin input. In some embodiments, the load sharing control device supports the use of a set of discrete current limits. For example, a load sharing control device may support current limits of 0.5 A, 0.9 A, 1.0 A, 1.2 A, 1.5 A, 1.8 A, 2.0 A, 2.5 A, 3.0 A or 3.5 A. In some embodiments, the current limit of the load sharing control device is configurable by the user. Based on a user configuration, the current limit for the load sharing control device is selected from one of the supported current limit values.

At step 110, the load sharing control device monitors the supported power ports in order to detect the connection of a USB device to one of the supported power ports. Once the load sharing control device has detected the attachment of a USB device to a supported power port, the process continues at step 115. At step 115, the load sharing control device determines if the newly-attached USB device is the only device connected to a power port supported by the controller. If it is determined that a newly-attached device is not the first device connected to a power port supported by the load sharing control device, the process continues at step 125. If the newly-attached USB device is the only USB device connected to a supported power port, at step 120, the load sharing control device designates the power port at which the USB device attachment has been detected as the priority power port. In allocating available power between the supported power ports, the load sharing control device allocates available power to the priority port first based on the current drawn by the USB device attached to the priority port. If the current required to power the priority port is less than the current limit available by the load sharing control device, the remaining current can be allocated by the load sharing control device to any USB devices connected to the other power ports supported by the power controller. Also at step 120, according to some embodiments, the load sharing control device sets a current limit for the priority port. If the USB device connected to the priority port is the only USB device connected to the load sharing control device, the current limit for the priority port may be set to the current limit for the load sharing control device.

In some embodiments a failsafe current will be assigned to a second-connected USB device. As described, assignment of a minimum current level for a non-priority port improves that ability to maintain at least minimal connectivity with a device connected to the non-priority port and/or prevent complete discharge of the devices battery. In such embodiments, this failsafe current will be assigned at step 160, upon detection of a second-connected downstream device. At such point, the load sharing control device selects an appropriate failsafe current level and, based on that selection, sets the current limit for the non-priority port. By assigning a failsafe current to the non-priority port, the power budget of the load sharing control device is reduced accordingly. For instance, if the port power controller has current limit of 3 A and failsafe current of 0.5 A is assigned to a non-priority port, the available current in the power budget of the load sharing control device is reduced to 2.5 A. The load sharing control device uses this remaining current, after the failsafe set aside, to supply current to the priority port at step 140.

As step 125, the load sharing control device monitors the power ports it supports in order to detect whether any USB devices have been disconnected from a supported power port. At step 155, it is determined whether the detected disconnection is at the priority port of the load sharing control device. If a disconnection at the priority power port is detected, the process continues at step 130 as the load sharing control device re-assigns the priority port designation. Otherwise, if the disconnection is detected at a non-priority power port, the process continues at step 110. At step 130, the load sharing control device re-assigns the priority power port, in response to the detected disconnection of the power port that is presently designated as the priority port. If a USB device is connected to a non-priority power port, the load sharing control device re-designates that power port as the priority port. If multiple devices are connected to non-priority power ports, the load sharing control device selects the first-connected of these devices as the recipient of the priority designation.

At step 135, the load sharing control device measures the current drawn by the USB device connected to the priority port. As the device with the priority port, the load sharing control device will attempt to supply current that could be drawn by the device connected to the priority port. The measurement of the current drawn by a USB device connected to a power port of the load sharing control device can be accomplished using techniques and components known in the art. Once the current draw of the USB device connected to the priority port is determined, the process continues as step 140.

At step 140, using the current measured in step 135, the load sharing control device sets the current limit for the priority port. This priority port current limit is an upper limit on the current that the load sharing control device will provide on the Vbus line of the priority port USB connection. As the power port designated as the priority port, the load sharing control device seeks to satisfy the power requirements of the USB device connected to this port first. However, in order to conserve as much possible for powering non-priority ports, the load sharing control device seeks to provide no more current on the priority port than is necessary for meeting the power requirements of the priority port USB device. The load sharing control device enforces an allocation of available current between the supported ports by assigning current limits to each port. According to some embodiments, the current limits of individual ports can be enforced only at the discrete current levels supported by the load sharing control device. The load sharing control device assigns one of these discrete current limit settings to each power port, starting with the priority port. The load sharing control device selects the lowest available current limit for the priority port that is greater than the measured current draw of the priority port USB device. In this manner, the load sharing control device manages its power budget by allocating no more power than is necessary to the priority port.

At step 145, the load sharing control device allocates the remaining current from its power budget to the non-priority port. The load sharing control device selects a current limit setting that allocates as much of the remaining available current to the non-priority port. As with the priority port, the load sharing control device selects a current limit for the non-priority port from the set of available current limits. The load sharing control device selects the highest current limit that, when combined with the priority port current allocation from step 140, does not exceed the current limit of the load sharing control device (I_{TOTAL}).

This determination of an efficient allocation of available power by the load sharing control device is not static. As the battery levels of the USB devices connected to the power ports change, the power requirements of these USB devices changes. For instance, where the power provided via the power ports is used to charge the internal batteries of USB devices, the current drawn by each USB device will decrease as the charge level of its internal battery increases. In order to maintain efficient allocation of power over time, the load sharing control device repeats the load sharing routine on a periodic basis. In some embodiments, the load sharing control device repeats its measurement of the current drawn by the priority port USB device on a periodic basis. In some embodiments, different periodic intervals can be configured for repeating the load sharing routine. For instance, a load sharing control device may be configurable such that the current limit of the priority port is evaluated either every 6.4 seconds or every 0.8 seconds, at T_{REASSIGN} step 150, according to configuration of the load sharing control device. Various embodiments may provide different configurable periodic intervals for repeating the load sharing routine.

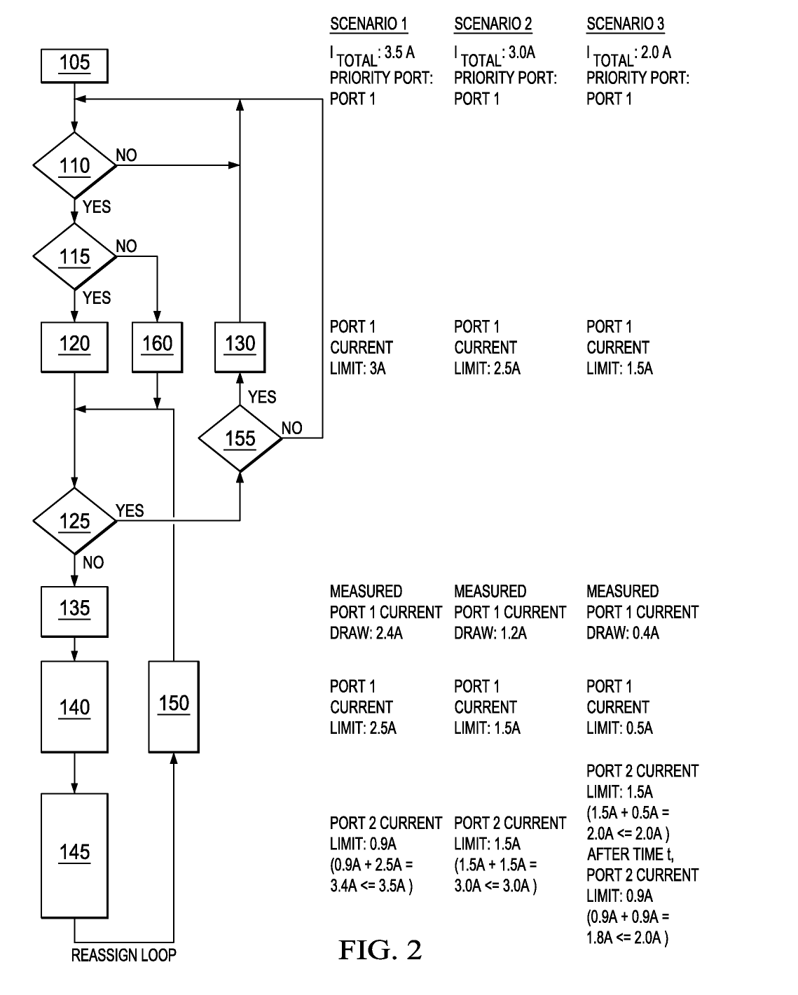

FIG. 2 illustrates three load sharing scenarios according to the load sharing routine described with respect to FIG. 1. In each of the scenarios, the load sharing control device allocates an available power budget among two power ports, one of which (Port 1) has been designated as the priority port. The load sharing control device assigns current limits to each of the power ports where the current limit settings available to the load sharing control device can provide either 0.5 A, 0.9 A, 1.5 A, 2.0 A, 2.5 A or 3.0 A of current to each of the power ports.

In Scenario 1 of FIG. 2, the power budget available to the load sharing control device is 3.5 A of supply current that the load sharing control device can allocate among supported ports. The attachment of a downstream USB device is detected on Port 1 of the load sharing control device. As the first-connected port, the load sharing control device designates Port 1 as the priority port. The load sharing control device assigns an initial current limit of 3 A to the priority port, the maximum current limit setting available that is less than the 3.5 current limit of the load sharing control device. A measurement of the current drawn by the device connected to Port 1 results in a reading of 2.4 A. The load sharing control device adjusts the Port 1 current limit to 2.5 A, the available lowest current limit setting greater than the current drawn by the device connected to Port 1. The remaining current in the power budget is then allocated to a USB device connected to the non-priority port (Port 2) of the load sharing control device. Although there is 1.0 A of current remaining in the load sharing control device's power budget, the load sharing control device selects a current limit from a list of supported current limits. The load sharing control device selects the highest available current limit setting for the non-priority port that, when combined with the 2.5 A current limit of the priority port, does not exceed the current limit of the load sharing control device. In this case, the 0.9 A setting is the highest current limit that can be assigned to the non-priority port while not violating the power budget.

In Scenario 2 of FIG. 2, the power budget available to the load sharing control device is 3.0 A. The attachment of a downstream USB device is detected on Port 1 of the load sharing control device. As the first-connected port, the load sharing control device designates Port 1 as the priority port. The load sharing control device assigns an initial current limit of 2.5 A to the priority port, the maximum current limit setting available that is less than the 3.0 A current limit of the load sharing control device. A measurement of the current drawn by the device connected to Port 1 results in a reading of 1.2 A. The load sharing control device adjusts the Port 1 current limit to 1.5 A, the available lowest current limit setting greater than the current drawn by the device connected to Port 1. After the allocation of 1.5 A to Port 1, the load sharing control device has 1.8 A remaining in its power budget. The load sharing control device selects the highest available current limit setting, 1.5 A, for the non-priority port that does not exceed this budget.

In Scenario 3 of FIG. 2, the power budget available to the load sharing control device is 2.0 A. The attachment of a downstream USB device is detected on Port 1 of the load sharing control device. As the first-connected port, the load sharing control device designates Port 1 as the priority port. The port controller assigns an initial current limit of 1.5 A to the priority port, the maximum current limit setting available that is less than the 2.0 A current limit of the load sharing control device. A measurement of the current drawn by the device connected to Port 1 results in a reading of 0.4 A. The load sharing control device adjusts the Port 1 current limit to 0.5 A, the available lowest current limit setting greater than the current drawn by the device connected to Port 1. After the allocation of 0.5 A to Port 1, the load sharing control device has 1.5 A remaining in its power budget. The load sharing control device selects the highest available current limit setting, 1.5 A, for the non-priority port that does not exceed this budget. In Scenario 3, the load sharing control device continues power allocation by measuring the current drawn on the priority port upon expiration of the pre-defined interval between automatic re-assignment of available current. At this second time, the current draw on the priority port has increased from 0.4 A to 0.8 A. In response to this change, the load sharing control device adjusts current limit of the priority port to 0.9 A, the available lowest current limit setting greater than increased current draw. After this adjustment of current supplied by the power port, the remaining current in the power budget is 1.1 A. The load sharing control device adjusts the current output of the non-priority port to 0.9 A, the highest available current limit setting that does not exceed the remaining power budget. In this manner, the load sharing control device periodically evaluates the demand for current by the priority port and re-allocates its power budget accordingly to provide automatic load sharing.

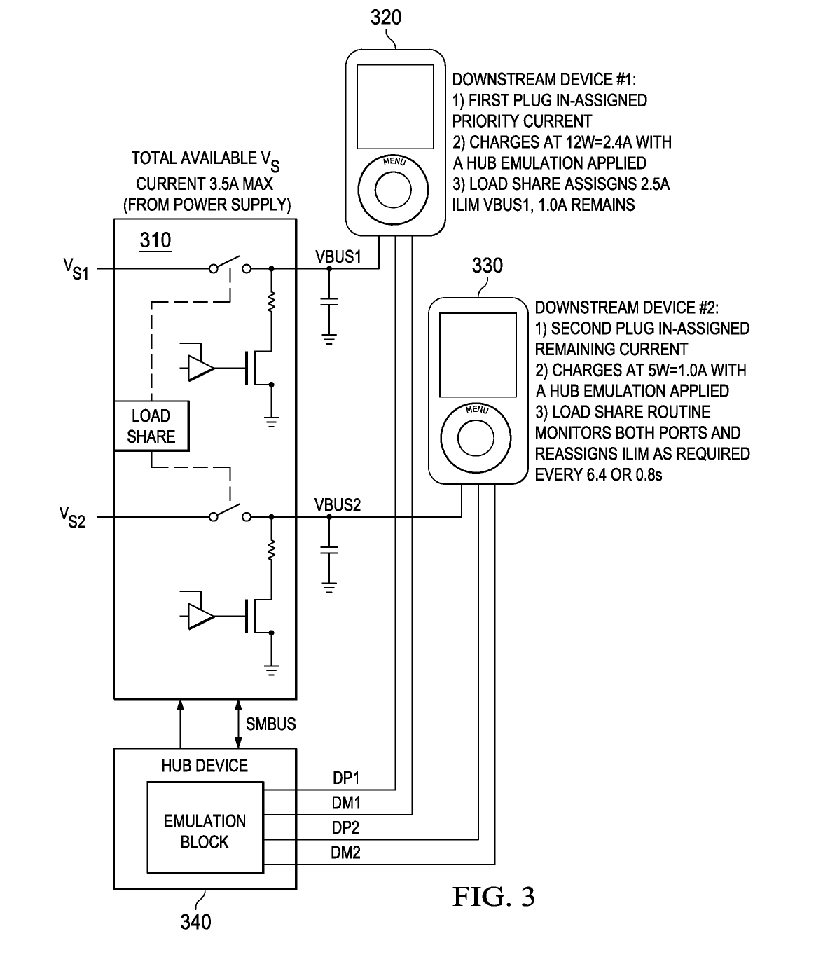

FIG. 3 illustrates the operation of a load sharing control device 310 according to some embodiments. The load sharing control device 310 communicates with a hub device 340. The load sharing control device 310 receives one or more power inputs, Vs1 and Vs2 in the embodiment of FIG. 3. The load sharing control device 310 controls the distribution of this input power on the Vbus lines of the USB interface to connected USB devices. The hub device 340 controls the transmission of data on the DP and DM data lines of the USB interface.

The load sharing control device 310 and the hub device 340 combine to provide a USB interface that can be used to connect with other USB-enabled devices. In the embodiment of FIG. 3, the load sharing control device 310 and the hub device 340 combine to provide a USB interface to which two portable devices, downstream device 320 and downstream device 330 are coupled. According to the various embodiments, these two downstream devices can be any type of USB device that draws power on the Vbus line for operation or for charging of internal batteries. In the embodiment of FIG. 3, both downstream device 320 and downstream device 330 are internal battery powered portable devices connected via USB cables to the USB interface provided using load sharing control device 310 and the hub device 340.

Both downstream device 320 and downstream device 330 communicate via USB data lines with hub device 340 and receive power from the load sharing control device 310. Based on data transmissions with the hub device 340 and power transmissions from the load sharing control device 310, the downstream devices re-charge their internal batteries and potentially receive operating power. In certain embodiments, the hub device 340 will also select among various charger emulation profiles that specify charging protocols for various types of devices. Based on data signals transmitted via the DP and DM lines with the downstream devices, the hub device 340 may select a charger emulation profile that allows for charging of the downstream devices to proceed as efficiently as possible using a charging protocol that is preferred by each individual downstream device. As described, the load sharing control device 310 allocates power to downstream devices through repeated assessment of the power being drawn by the downstream devices. Information used and generated by the load sharing control device 310, such as the present limits on the current available to each downstream device can be utilized by the hub device 340 in the selection of charger emulation profiles. Such power budget information available at the load sharing control device 310 can be polled by the hub device 340 over a System Management Bus (SMBus) connecting the two components. The hub device can use this information to select the most efficient charger emulation profiles under the present power constraints being enforced by the load sharing control device. In certain embodiments, the features of hub device 340 may be provided by internal USB hubs, for instance USB hubs manufactured by Microchip similar to internal USB hubs identified as model numbers USB5534 and USB5734.

As illustrated in FIG. 3, the load sharing control device 310 distributes power to first downstream device 320 and second downstream device 330. In the illustrated embodiment, first downstream device 320 is connected to a power port of the USB host first and, in response, power port to which the first downstream device 320 is connected is assigned priority status by the load sharing control device 310. As the downstream device on the priority status power port, the load sharing control device 310 is configured to prioritize power distribution to downstream device 320. As described, the load sharing control device 310 periodically determines the current that is drawn by the first downstream device 320 and chooses an internal power setting that has an output current level on the Vbus connection to the downstream device that is at or above the current draw of the downstream device. And, as described, the load sharing control device 310 selects an output current level from a set of discrete output levels where the selected output current is the lowest possible output current setting that is greater than the current drawn by the first downstream device 320. Any remaining current that is available to the load sharing control device 310 can be allocated to a second-connected device, such as the second downstream device 330, that is connected to a non-priority power port of the load sharing control device.

In some embodiments, the detection of a second-connected downstream device results in the load sharing control device 310 allocating a minimum failsafe current for the second-connected downstream device. This failsafe current is a current level that prevents power starvation at the second-connected downstream device. In some embodiments, this allows some minimum level of operation by the second-connected downstream device. For instance, in the embodiment of FIG. 3, the load sharing control device 310 assigns the second-downstream device a failsafe current of 500 mA, which allows for USB enumeration of the second-connected downstream device. In some embodiments, the failsafe current level assigned to a non-priority port may be a trickle charge current level that is sufficient to prevent complete discharge of the internal batteries of a second-connected downstream device. In embodiments that utilize a failsafe current, the selected failsafe current level is set aside from the power budget of the load sharing control device 310. The remaining current in the power budget is allocated by the load sharing control device 310, with priority given to the priority port.

When the first-connected downstream device is disconnected from a power port that has been designated as the priority power port, the load sharing control device 310 reassigns the power port of any second-connected downstream device as the priority power port. The second-connected downstream device now receives priority in power allocation by the load sharing control device 310 and assumes the role of the first-connected downstream device relative any later connected devices. In some embodiments, this change in the designation of the priority power port by the load sharing control device 310 may be communicated to the hub device 340 over the SMBus. The hub device 340 may then utilize this information to update its selection of the charger emulation profile for the re-designated power ports.

Referring back to the embodiment of FIG. 3, the first downstream device 320 is the first-connected device and the power port to which it is connected is thus designated as the priority port. Upon USB enumeration, the first downstream device 320 begins to draw power from the load sharing control device 310 via the VBus line of the USB interface. The load sharing control device 310 determines that the first downstream device 320 draws 12 W of power at 2.4 A of current. These are the power and current levels for transferring charge to the first downstream device 320. In some embodiments, this power level at which the first downstream device 320 should be charged is determined by the charger emulation profile that has been selected by the hub device 340.

With the preferred charging levels of the first downstream device 320 determined, the load sharing control device 310 then determines the actual power output that it will transmit on the VBus connection to the first downstream device. In some embodiments, the load sharing control device 310 will select an output power level from among a set of discrete power levels that the load sharing control device 310 is capable of supporting. In the embodiment of FIG. 3, the load sharing control device 310 is capable of VBus outputs that provided one of 0.5 A, 0.9 A, 1.0 A, 1.2 A, 1.5 A, 1.8 A, 2.0 A or 2.5 A of current. In order to satisfy the 2.4 A preferred charging level of the first downstream device 310, the load sharing control device 310 selects the 2.5 A output current limit from the list of available output current levels and transmits this current level on the VBus1 line. The 2.5 A output current selected by the load sharing control device 310 is selected because it is the lowest output current level of the load sharing control device 310 that is greater than the preferred charging current for the first downstream device 320.

With the actual output current on the priory power port by the load sharing control device 310 established, the remaining current can be allocated to a second-connected device, such as the second downstream device 330. In the embodiment of FIG. 3, the load sharing control device 310 receives a 3.5 A supply current and thus limited to a maximum output current of 3.5 A across all power ports supported by the load sharing control device 310. In some embodiments, the maximum output current of the load sharing control device 310 is configurable such that a user can select an upper limit on the output current that is less than the true maximum output current that the load sharing control device 310 is capable of providing. In the embodiment of FIG. 3, once the output current for the priority port has been determined to be 2.5 A, the load sharing control device 310 can allocate the remaining 1.0 A to charging the second downstream device 330.

As described, once the load sharing control device 310 has allocated available power to charging of the first downstream device 320 and the second downstream device 330, the load sharing control device 310 continues to monitor the current draws of the two downstream devices. As the internal batteries of the two downstream devices are charged, the amount of current drawn by each of the downstream devices changes. In order to detect any such changes, the load sharing control device 310 periodically measures the current drawn by each of the downstream devices. The load sharing control device 310 continues to allocate available power to the first downstream device 320 connected to the priority power port before providing any remainder current to second downstream device 330. The load sharing control device 310 responds to a decrease in current drawn by the first downstream device 320 by attempting to drop its current output level to the first downstream device 320. If the output current level to the first downstream device 320 can be dropped, the load sharing control device 310 diverts the increase in the remainder current to the second downstream device 330. In the embodiment of FIG. 3, a drop in the measured current draw of the first downstream device 320 from 2.4 A to 1.6 A results in the load sharing control device 310 dropping its output current to the first downstream device 320 from 2.5 A to 1.8 A, the lowest current limit supported the load sharing control device 310 that is sufficient to provide the current drawn by the first downstream device 320. This results in an additional 0.7 A of current that the load sharing control device 310 allocates to the charging of the second downstream device, raising the available output current on VBus2 from 1.0 A to 1.7 A. The load sharing control device 310 raises the output current limit for the second downstream device to 1.5 A, the greatest supported current limit that does not exceed the 1.7 A that is available. In this manner, the load sharing control device 310 makes periodic measurements of the current drawn by the downstream device and re-allocates any spare charging power among the devices.

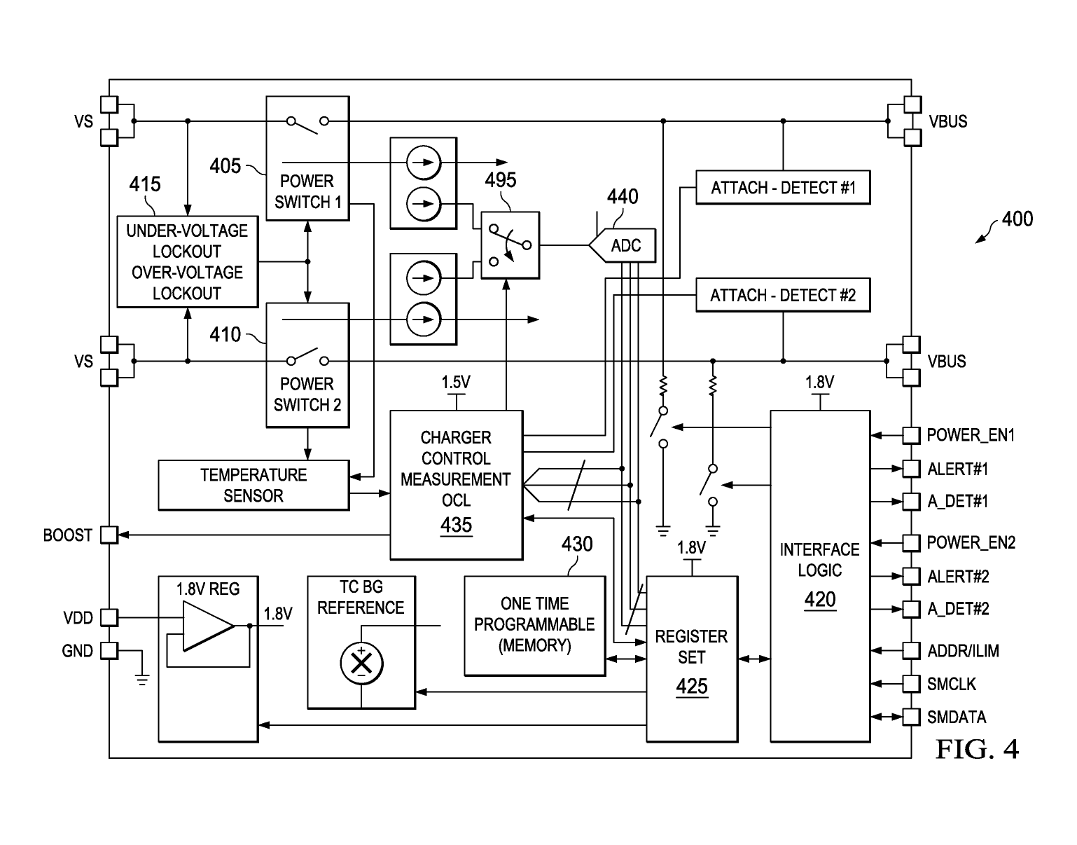

FIG. 4 shows an exemplary block diagram of a load sharing control device, for example, the device 310 shown in FIG. 3, according to various embodiments. The load sharing control device 400 receives inputs and communicates outputs via pins connected to interface logic 420. One of the inputs received via the interface logic is the current limit (ILIM) of the load sharing control device 400. This is the maximum current draw of the load sharing control device 400 and is the current supply that is allocated among the power ports supported by the load sharing control device 400. Inputs, such as the ILIM setting for the load sharing control device may be stored in register set 425. In some embodiments, the current limit settings in use for each of the supported power ports are also stored in register set 425. Register values may also be populated based on information stored in one-time programmable memory (OTP) 430. The load sharing logic of the load sharing control device 400 may access the register set in order to retrieve the ILIM settings presently in use for the load sharing control device 400 and for each of the supported power ports.

Power is supplied to the load sharing control device 400 via power pins (Vs). In some embodiments, separate pins deliver power for each of power supply pins (V_{BUS}) supported by the load sharing control device 400. Each power supply pin is used to transfer charge to a downstream device. The load sharing control device 400 regulates the power delivered to a downstream device via the power supply pins. The load sharing control device 400 may also regulate input power using under-voltage lockout 415 and over-voltage lockout circuits 415. When under-voltage or over-voltage conditions are detected the lockout circuits 415 trip power switches 405, 410 that control the supply of power to each power port. Each of the switches 405, 410 provide for independent operation of the USB ports, such that each of the ports can be independently enabled or disabled, the detection of attachment and removal at each port is independently determined and fault-handling for each port is isolated from other ports.

The load sharing control device 400 allocates its power budget, determined by the device's current limit (ILIM), between each of the power supply pins supported by the device. A logic unit 435 implements the load sharing routine and controls the allocation of available power between the supported power supply pins. The logic unit 435 retrieves setting information from the register set 425. The logic unit 435 applies these settings in the allocation of power between the supported power supply pins. The logic unit 435 relies on attachment detection circuits to determine when downstream devices have been connected to the load sharing control device 400 via the power supply pins. Once downstream device(s) have been connected to the load sharing control device 400, the ADC/current measuring unit 440 measures the current drawn by the downstream device(s) in order to determine if the current limits can be re-allocated, a device has been removed, or if the BOOST# output is asserted. The logic control unit 435 additionally includes internal timers that are used to implement and adjust the re-assignment delay, T_{REASSIGN}, and other timing functions.

In some embodiments, the logic unit 435 controls a BOOST# logic output that requests a temporary increase in the input voltage Vs in order to accommodate large loads. The BOOST# logic output from the load sharing device 400 is asserted whenever the current draw on either output port exceeds a pre-determined threshold, for example 2.0 A, as determined the ADC/current-measurement unit 440. The system power supply can monitor the BOOST# output and, if asserted, respond by raising the Vs/Vbus voltage to compensate for the heavy load current. The load sharing control device 400 can then distribute this additional power to the supported power supply pins.

The load sharing control device 400 can function, according to various embodiments, as part of different components in a USB system. The load sharing control device 400 can function as a stand-alone USB port power switch, which may be an embedded component of a USB port power controller. The load sharing control device 400 may also be implemented as a subcomponent of a USB hub or a component of a charge emulator located within the USB system.

What is claimed is:

1. A method for allocating power to a first device and a second device comprising:
measuring a current drawn by the first device, wherein the first device is connected to a first port of a load sharing control device and wherein the load sharing control device has a total current limit and wherein the load sharing control device has a plurality of current limit settings;
designating the first port of the load sharing control device as a priority port;
assigning a first current limit to the priority port wherein the assigned first current limit is the lowest current limit setting of the load sharing control device that is greater than the measured current draw of the first device connected to the priority port; and
assigning a second current limit to a second port of the load sharing control device wherein the assigned second current limit is the highest current limit setting of the load sharing control device that is less than or equal to the total current limit of the load sharing control device minus the first current limit.

2. The method of claim 1, further comprising:
waiting a predefined time interval before updating the measurement of the current drawn by the first device; and
updating the first current limit assignment and the second current limit assignment based on the updated measurement of the current drawn by the first device.

3. The method of claim 1, further comprising:
assigning a failsafe current level to the second port wherein the failsafe current level is deducted from the total current limit of the load sharing control device.

4. The method of claim 1, further comprising:
detecting the disconnection of the first device from the priority port; and
designating the second port of the load sharing device as the priority port.

5. The method of claim 2, further comprising:
adjusting the predefined time interval.

6. The method of claim 1, further comprising:
issuing a request to boost the input voltage to the load sharing control device based on the measured current drawn by the first device or the measured current drawn by the second device.

7. The method of claim 1 wherein the total current limit of the load sharing control device is configurable.

8. A load sharing control device comprising:
a first port designated as a priority port upon detection of the connection of a first device to the first port;
a second port wherein a second device is connected to the second port;
a first current measurement circuit configured for measuring the current drawn by the first device connected to the first port of the load sharing control device wherein the load sharing control device has a total current limit and wherein the load sharing control device has a plurality of current limit settings; and
a logic unit configured to assign a first current limit to the priority port, wherein the first current limit is the lowest current limit setting of the load sharing control device that is greater than the measured current draw of the first device connected to the priority port and further configured to assign a second current limit to the second port of the load sharing control device and, wherein the second current limit is the highest current limit setting of the load sharing control device that is less than or equal to the total current limit of the load sharing control device minus the first current limit.

9. The load sharing device of claim 8, wherein the logic unit is further configured to update the measurement of the current drawn by the first device after waiting a predefined time interval and further configured to update the first current limit assignment and the second current limit assignment based on the updated measurement of the current drawn by the first device.

10. The load sharing device of claim 8, wherein the logic unit is further configured to assign a failsafe current level to the second port wherein the failsafe current level is deducted from the total current limit of the load sharing control device.

11. The load sharing device of claim 8, wherein the second port is designated as the priority port upon detection of the disconnection of the first device from the first port.

12. The load sharing device of claim 9, wherein the logic unit is further configured to adjust the predefined time interval.

13. The load sharing device of claim 8, wherein the logic unit is further configured to issue a request to boost the input voltage to the load sharing control device based on the measured current drawn by the first device or the measured current drawn by the second device.

14. The load sharing device of claim 8, wherein the total current limit of the load sharing control device is configurable.

15. A load sharing system for allocating power to a first device and a second device wherein the load sharing system has a total current limit and wherein the load sharing control device has a plurality of current limit settings, the system comprising:
a first port designated as a priority port upon detection of the connection of a first device to the first port;
a second port wherein a second device is connected to the second port;
a first current measurement circuit configured for measuring the current drawn by the first device connected to the first port;
a load sharing control logic unit configured to assign a first current limit to the priority port wherein the first current limit is the lowest current limit setting of the load sharing system that is greater than the measured current draw of the first device connected to the priority port and further configured to assign a second current limit to the second port, wherein the second current limit is the highest current limit setting of the load sharing system that is less than or equal to the total current limit of the load sharing system minus the first current limit.

16. The load sharing system of claim 15, wherein the load sharing control logic unit is further configured to update the measurement of the current drawn by the first device after waiting a predefined time interval and further configured to update the first current limit assignment and the second current limit assignment based on the updated measurement of the current drawn by the first device.

17. The load sharing system of claim 15, wherein the load sharing control logic unit is further configured to assign a failsafe current level to the second port wherein the failsafe current level is deducted from the total current limit of the load sharing system.

18. The load sharing system of claim 15, wherein the second port is designated as the priority port upon detection of the disconnection of the first device from the first port.

19. The load sharing system of claim 16, wherein the load sharing control logic unit is further configured to adjust the predefined time interval.

20. The load sharing system of claim 15, wherein the load sharing logic unit is further configured to issuing a request to boost the input voltage to the load sharing control based on the measured current drawn by the first device or the measured current drawn by the second device.
